(19) United States
(12) Patent Application Publication
(10) Pub. No.: US 2011/0048871 A1
(43) Pub. Date: Mar. 3, 2011

(54) BRAKE ROTORS, DISK ASSEMBLIES, AND OTHER COMPONENTS

(76) Inventor: NATHAN K. MECKEL, Vista, CA (US)

(21) Appl. No.: 12/848,429

(22) Filed: Aug. 2, 2010

Related U.S. Application Data
(63) Continuation-in-part of application No. 12/533,933, filed on Jul. 31, 2009.
Application No. 12/533,933 is a continuation-in-part of application No. 12/195,994, filed on Aug. 21, 2008.
(60) Provisional application No. 61/230,625, filed on Jul. 31, 2009.
(60) Provisional application No. 60/957,422, filed on Aug. 22, 2007.
(60) Provisional application No. 60/971,879, filed on Sep. 12, 2007.

(51) Int. Cl. F16D 55/226; F16D 65/12; F16D 65/847; B23P 19/00

(52) U.S. Cl. 188/71.6; 188/71.1; 29/426.2

(57) ABSTRACT

A vehicle braking system can include a rotating braking element that includes a bulk structural material and a friction surface. The friction surface can include an outer coating that includes a corrosion and wear-resistant material. The rotating brake element can be adapted for installation as part of a braking system on the vehicle. The vehicle braking system can also include a movable brake member that includes a friction material having a friction material composition. The movable brake member can be disposed in the braking system with the friction material disposed opposite at least one friction surface so that the friction material reversibly engages with the outer coating of the corrosion and wear-resistant material when the braking system is operated to stop or slow the vehicle. The outer coating of the corrosion and wear-resistant material can include a decorative color whose color and original appearance are substantially retained after repeated uses in stopping or slowing the vehicle.

### CROSS-REFERENCE TO RELATED APPLICATIONS

The current application claims the benefit of priority under 35 U.S.C. §119(e) of U.S. provisional patent application Ser. No. 61/230,625, filed on Jul. 31, 2009.

The current application is also a continuation-in-part of co-pending application for U.S. patent Ser. No. 12/533,933, filed on Jul. 31, 2009 and entitled “Reduction of Particulate Emissions from Vehicle Braking Systems,” and also a continuation-in-part of co-pending application for U.S. patent Ser. No. 12/195,994, filed on Aug. 21, 2008 and entitled “Brake Disk and Method of Making Same,” which claims the benefit of U.S. provisional patent application Ser. No. 60/957,422, filed on Aug. 22, 2007 and U.S. provisional patent application Ser. No. 60/971,879, filed on Sep. 12, 2007. All applications to which the current application claims priority are incorporated by reference herein in their entireties.

### TECHNICAL FIELD

The subject matter described herein relates to braking systems of vehicles. For the purposes of this disclosure, the term “vehicle” includes, but is not limited to, automobiles, motorcycles, motorized scooters, on and off-road vehicles electric vehicles such as golf carts, light and heavy duty trucks, road tractors and semi-trailers, vans, off-road vehicles such as all-terrain vehicles and dune-buggies, trains, and the like. The subject matter disclosed herein is also applicable to braking systems used with aircraft landing gear, bicycles, military vehicles, and the like.

### SUMMARY

In various aspects a braking system component includes a bulk structural material and a friction surface. The friction surface can include an outer coating including a corrosion and wear-resistant material that can be created in one or more custom colors based on a chemical composition of the outer coating.

Optional variations of these aspects can include one or more of the following features. The outer coating of the corrosion and wear-resistant material can include a first layer that includes a crystalline material and a second layer overlaying and contacting the first layer and that includes an amorphous material. The friction surface can include a plurality of raised island formations separated by channels or gaps that permit air flow to cool the rotating braking element during active engagement with the brake member. The first layer and the second layer can have an inter-layer period of less than 10 nm and the outer coating can include a super-lattice structure. The first layer can include one or more amorphous metals and the second layer can include one or more binary metals. The amorphous metal of the first layer can be selected from titanium, chromium, zirconium, aluminum, hafnium and an alloy combination thereof. The binary metal of the second layer can be selected from a metal nitride, a metal boride, a metal carbide and a metal oxide. The second layer further can include one or more nitrides, borides, carbides or oxides of the amorphous metal of the first layer. The braking system component can include a brake disk or rotor.

The subject matter described herein provides many advantages that can include, but are not limited to reducing the wear rate of brake system friction components without sacrificing braking performance. Additionally, the corrosion and wear-resistant coating material can be provided in a number of custom colors to coordinate with other features of a vehicle. Because the corrosion and wear-resistant coating is highly durable even under extreme conditions such as might occur during frictional braking activities, the custom color can be long lasting, potentially for as long as the useful life of the braking system component.

The details of one or more variations of the subject matter described herein are set forth in the accompanying drawings and the description below. Other features and advantages of the subject matter described herein will be apparent from the description and drawings, and from the claims.

### BRIEF DESCRIPTION OF DRAWINGS

The accompanying drawings, which are incorporated in and constitute a part of this specification, show certain aspects of the subject matter disclosed herein and, together with the description, help explain some of the principles associated with the disclosed embodiments. In the drawings,

FIG. 1 is a perspective diagram illustrating a brake disk or rotor;

FIG. 2 is a diagram showing a top plan view of a brake disk or rotor;

FIG. 3 is a diagram showing a cross-sectional view of a brake disk or rotor;

FIG. 4 is a diagram showing an expanded cross-sectional view of a brake disk or rotor surface;

FIG. 5 is a diagram showing a closer expanded cross-sectional view of a brake disk or rotor surface;

FIG. 6 through FIG. 18 are diagrams showing two views each of various implementations of brake rotors and floating rotor assemblies consistent with the current subject matter; and

FIG. 19 is a process flow diagram illustrating a method.

Similar reference numerals in the drawings are intended to denote similar structures or other features of the described subject matter.

### DETAILED DESCRIPTION

The braking system of a vehicle typically includes one or more friction components that are pressed into contact to transform kinetic energy of the motor vehicle into heat and thereby slow the vehicle. These friction components can include a wheel-mounted rotating device, such as for example a rotor (also referred to as a brake disk) or drum and a movable device such as for example a brake pad or shoe, that is moved via a braking mechanism so that a friction material on the moveable device is forcibly contacted with a friction surface of the wheel-mounted rotating device. The braking mechanism can be controlled by a user operable system, such as a foot-operated brake pedal or a hand-operated grip device and can be mechanical, electrical, or hydraulic.

For brake systems in which the rotating device is a rotor or a disk, the mechanism can be a set of calipers and a mechanical or hydraulic system for applying pressure to a movable device mounted to each caliper to urge it against the friction surfaces of the rotor or disk. The rotor or disk typically has two opposing friction surfaces on opposite annular faces of a disk-like structure. A central hole in the rotor or disk is configured to be mounted co-axially with the wheel. If the rotating device is a drum, the movable device can be one or more shoes. The drum is a cylindrical device whose axis is the same as that of the wheel to which it is mounted. The friction surface of the drum is on the outer rotation surface. The shoes are urged against the friction surface by calipers, levers, or other devices that are controlled by the user.

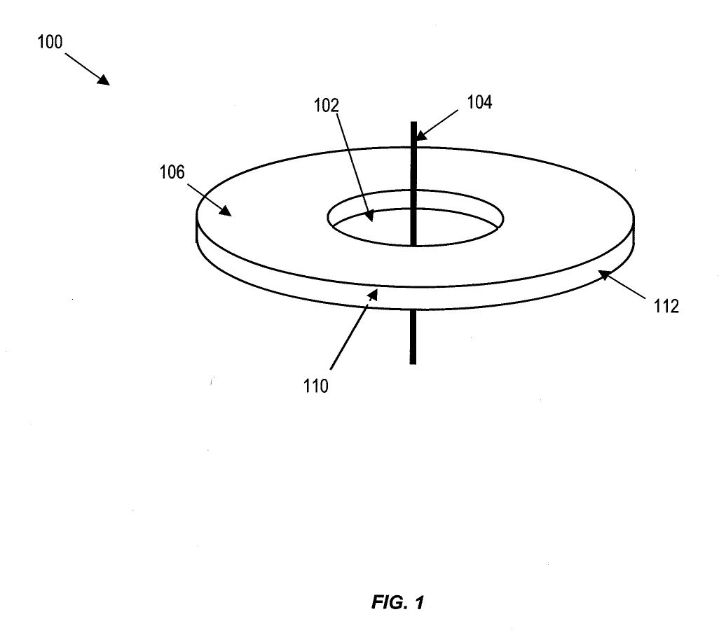

FIG. 1 shows an example of a brake disk or rotor 100 that has a disk-shaped body with a central hole 102 adapted so that the brake disk 100 can be positioned over the hub of a wheel (not shown) and centered on the axis of rotation 104 of the wheel and brake disk or rotor 100 assembly. The shape of the brake disk or rotor 100 and the central hole 102 are shown in FIG. 1 as having a circular cross-section normal to the axis of rotation 104. However, this is merely an example. The cross-section of either the brake disk or rotor 100 and the central hole 102 can be non-circular as long as they are rotationally symmetrical about the axis of rotation. Opposing annular surfaces 106 and 110 are disposed on opposite sides of the brake disk or rotor 100 and can extend from the outer periphery 112 of the brake disk or rotor 100 to the central hole 102. At least a portion of each of the annular surfaces 106 and 110 serves as a friction surface against which the friction material of the brake pads or shoes is urged during braking. A corrosion resistant coating can be applied to the friction surfaces as described in more detail below.

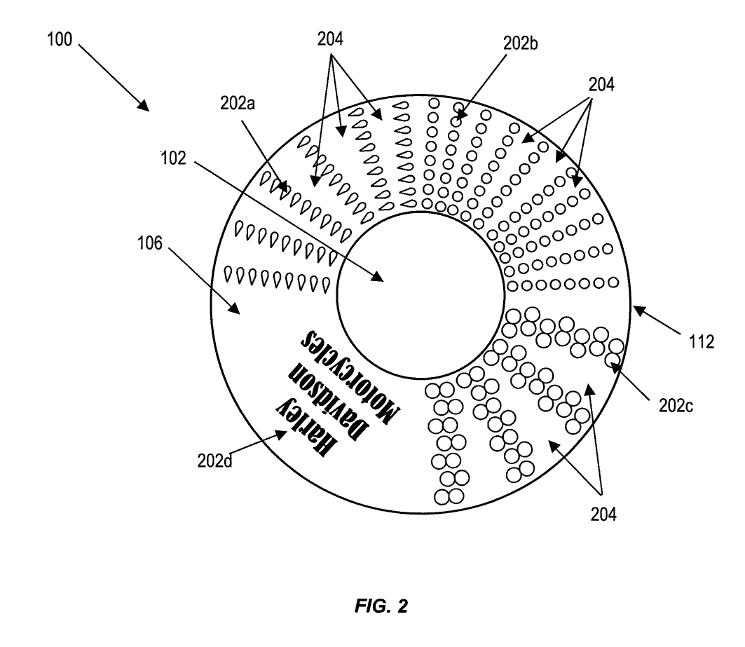

In some implementations, the friction surfaces disposed on annular surfaces 106 and 110 of brake disk or rotor 100 include a plurality of raised land portions or island formations 202 with spaced air flow channels 204 between the island formations 202. Only the raised portions of the island formations contact the brake pads or shoes during braking in this arrangement, and comprise the wear surfaces of the brake disk or rotor 100. FIG. 2 shows a face-on view of a brake disk or rotor looking from above at one of the annular surfaces 106 that includes some examples of possible land portions or island formations 202 on the friction surface. In FIG. 2, four different possible island formations 202 are shown in each of four quadrants of an annular surface 106 of a brake disk or rotor 100. The arrangement of the island formations 202 shown in FIG. 2 is for illustrative purposes. In general, a uniform pattern is used throughout the friction surface of an annular surface 106 of a brake disk or rotor 100. In some implementations, however, a combination of the features shown or other comparable surface features can be included. As shown in FIG. 2, the island formations 202 can include tear drop shaped formations 202a, circle or dot shaped formations 202b, figure eight shaped formations 202c, and letter shaped formations 202d, with channels or voids 204 between and/or around the island formations allowing air flow extending between the formations. As seen in three of the quadrants in FIG. 2, the island formations 202 can be arranged in rows which extend radially from the central opening 102 of the brake disk or rotor 100 out to the peripheral edge 112, with radial air flow channels 204 extending outwardly between each adjacent pair of rows of island formations 202, in addition to channels which extend between adjacent pairs of island formations 202 in each row.

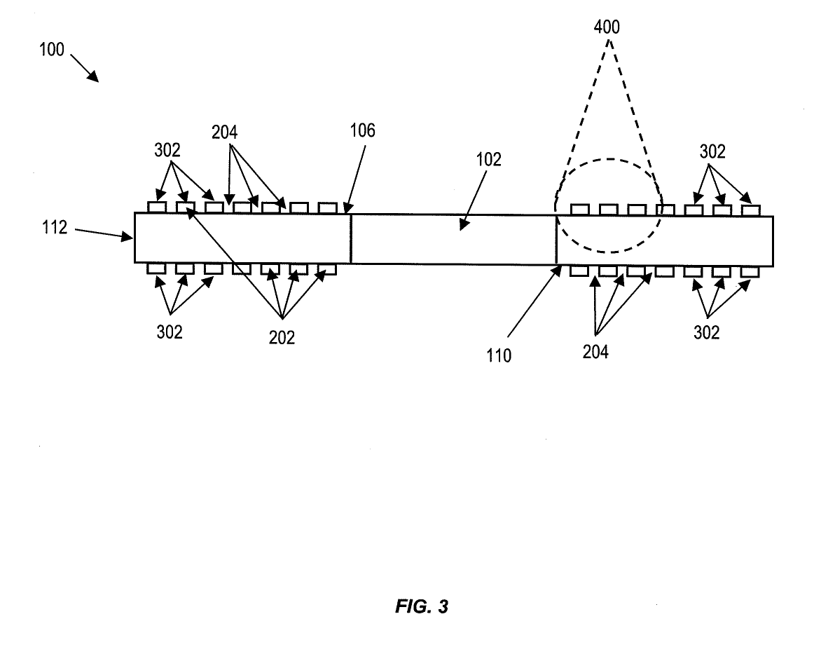

FIG. 3 shows a side cross sectional view of a brake disk or rotor 100 with the cross section taken along a diameter of the annular surfaces 106 and 110. As shown in FIG. 3, the island formations 202 have upper surfaces 302 which are at least substantially flat friction surfaces for contact with the brake pads or shoes during braking, and are designed with sufficient surface areas for braking purposes. Shapes and configurations of island formations 202 that differ from those shown in FIG. 2 and FIG. 3 can also be used, including but not limited to squares, trapezoids, rectangles, triangles, stars, letters or names, numbers, logos, trademarks, dashes, other geometric shapes, and the like, with or without rounded corners, can also be used to improve cooling and wear, to meet specific performance criteria, and/or to improve the aesthetic appearance of the brake disk or rotor 100.

Spaced island formations 202 arranged in a pattern to create cooling air channels and gaps 202 can be arranged to extend over an entire annular surface 106 and 110 of a brake disk or rotor 100. Alternatively, island formations 202 of any desired different shapes and sizes may be provided in patterns over the disk surface. The shape and positioning of the island formations 202 can be designed to be aesthetically pleasing in appearance which is particularly desirable when the disk surfaces are externally visible, as is the case with many motor cycle brake disks. The grooves or channels around the island formations 202 result in a significant reduction in the overall weight of the brake disk or rotor 100 which in turn improves the efficiency and performance of the motor vehicle. Additionally, the channels and gaps 204 allow for air flow around the island formations 202 for increased cooling and heat dissipation. The base of each channel or gap 204 can optionally be roughened or modulated to provide bumps or the like that create turbulence in air flow along the channel or gap 204 which can also improve the cooling effect.

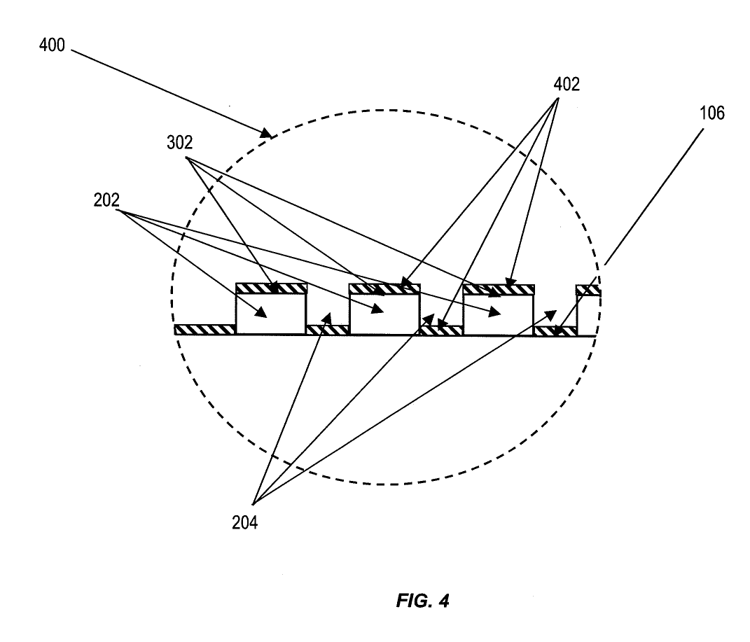

Island formations 202 of desired shapes and dimensions can be formed in any suitable manner, for example by appropriate machining or other forming processes. After machining, the desired island formations 202 on one or both annular surfaces 106 and 110 of the brake disk or rotor 100, the entire annular surface 106 of the brake disk or rotor 100 can be coated with a wear and corrosion resistant coating 402 which eliminates or greatly reduces the wear of the braking surfaces 302 of the island formations 202. FIG. 4 shows an expanded view 400 of a portion of the annular surface 106 of a brake disk or rotor 100 with island formations 302 and air flow channels or gaps 204. In FIG. 4, the wear and corrosion resistant coating 402 is deposited on the upward facing surfaces 302 of the island formations 202 and also in the air flow channels or gaps 204. Alternatively, the island braking surfaces alone can be coated with the wear and corrosion resistant coating 402. During the process of forming the wear and corrosion resistant coating 402, surface in addition to those shown as having the wear and corrosion resistant coating 402 in FIG. 4 can also be coated, either deliberately or incidentally. For example, the wear and corrosion resistant coating 402 can be deposited on the walls of the island formations 202, which are shown as vertical lines in FIG. 4. The wear and corrosion resistant coating 402 can improve the overall look or aesthetics of the brake disk or rotor 100.

In one implementation, the wear and corrosion resistant coating 402 includes a first layer of a metal, such as a pure titanium metal, and a second layer that includes a nitride, boride, carbide or oxide of the metal used in the first layer. The coating can be applied using a physical vapor deposition source such as a cathodic arc source with a controlled gas atmosphere. The materials used for the wear and corrosion resistant coating 402 can be of different colors and can be designed to produce different surface appearances, such as a light reflective, shiny appearance, for example, particularly on regions of the annular surfaces 106 and 110 that are visible when the brake disk or rotor 100 is installed on a vehicle.

A surface finish can be produced on the annular surfaces 106 and 110 of the brake disk or rotor 100 substrate, including the island formations 202, by blasting the annular surfaces 106 and 110 with a continuous stream of particles (commonly referred to as bead blasting) which are typically harder than the annular surfaces 106 and 110. These particles can be round and/or smooth in shape or alternatively very irregular in shape. Various particle shapes can be used to impart a different surface finish or surface geography to the brake disk or rotor 100. For example, with round particles (of various sizes) and appropriate particle energy (air pressure or hydro pressure) a surface texture that microscopically resembles low soft rolling hills can be achieved. With irregular (crystalline) shaped particles, a very coarse surface geometry (very rugged/jagged peaks and valleys) can be imparted to the brake disk or rotor 100 surfaces. Other methods such as a sanded or a ground surface finish can be used to give a different appearance when coated with the wear and corrosion resistant coating 402. When the sanded or ground surface finish is done in a cross-hatched configuration and then coated with the wear and corrosion resistant coating 402, the coated brake disk or rotor 100 can be made to look as though it has a woven appearance such as is found in components made from carbon fiber.

In general, there are a multitude of surface finish techniques that can be utilized to impart a specific surface texture or geometry into the brake disk or rotor 100 prior to application of a wear and corrosion resistant coating 402. In one implementation, selected surface finishes can be implemented as described in co-pending U.S. patent application Ser. No. 12/034,590 filed on Feb. 20, 2008, the entire contents of which are incorporated herein by reference. In alternative variations, only the braking surfaces 302 of the island formations 202 are treated to produce a surface texture, for example, by masking the channels or gaps 204 between the island formations 202 during bead blasting or other surface treatments.

The substrate forming the bulk of the brake disk or rotor 100 can include any suitable material, including but not limited to cast iron, stainless steel, light weight metal alloys, ceramic materials, ceramic composite materials, titanium, or combinations thereof. The wear and corrosion resistant coating 402 can optionally be applied using the fixtures, techniques and materials as described in co-pending application Ser. No. 12/034,590 referenced above, and in co-pending U.S. patent application Ser. No. 12/034,599 on Feb. 20, 2008, the entire contents of which are incorporated herein by reference.

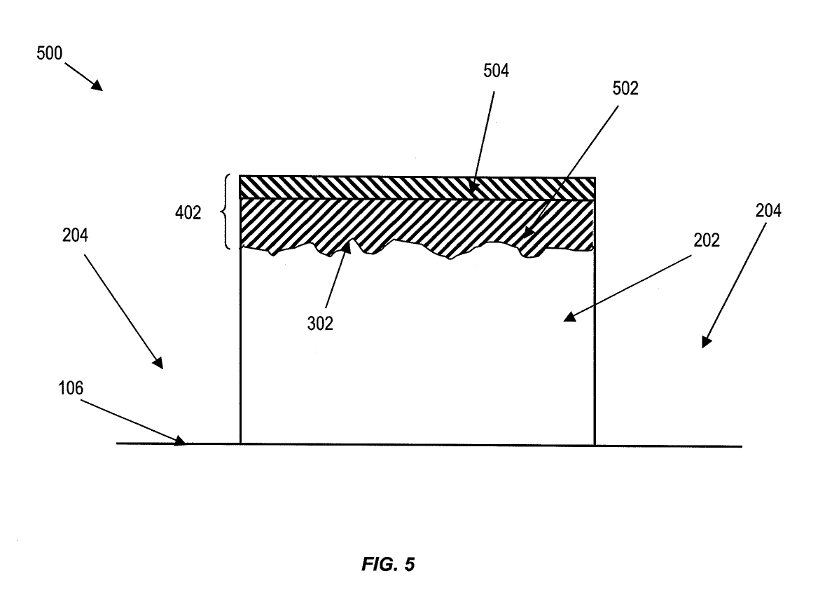

As shown in FIG. 5, which is a very expanded view 500 of an island formation 202 of a brake rotor or disk 100, the wear and corrosion resistant coating 402 sits upon the a braking surface 302 prepared as described above. The wear and corrosion resistant coating 402 can include a first layer 502 of a material having an amorphous structure (i.e. a non-crystalline structure) or a crystalline structure. This first layer 502 is applied directly onto the prepared braking surface 302. The amorphous or crystalline material can in some implementations be a metal such as titanium, chromium, zirconium, aluminum, hafnium or an alloy thereof. The wear and corrosion resistant coating 402 further includes a second layer 504 that overlays and contacts the first layer 502. Though the layers are depicted as distinct in FIG. 5, in some implementations, the first layer 502 and the second layer 504 intermingle or merge such that no distinct boundary exists between them. The second layer 504 can in some variations include one or more binary metals, for example, one or more metal nitrides, metal borides, metal carbides and metal oxides. The second layer 504 can alternatively or additionally include one or more nitrides, borides, carbides or oxides of the metal used in the first layer 502. In some implementations, the wear and corrosion resistant coating 402 can include more than two layers of alternating metal and metal compound materials that are applied in order to impart specific physical properties to the brake disk or rotor 100. In some implementations of a wear and corrosion resistant coating 402, the first layer 502 can include amorphous titanium and the second layer 504 can include a titanium nitride (TiN, Ti.sub.2N, etc.). Multiple alternating instances of the first layer 502 and the second layer 504 can be configured to form a lattice structure or a super lattice structure that includes thin films formed by alternately depositing two different components to form layered structures. Multilayers become superlatices when the period of the different layers is less than about 10 nm (100 Angstroms). With this cooperation of structure, a wear and corrosion resistant coating 402 having a service life to exceed approximately 100,000 vehicle miles or more can be obtained. it should be noted that abbreviations (e.g. TiN, Ti.sub.2N, etc.) are used herein as a shorthand rather than an exact chemical label, and do not suggest that the stoichiometry of the indicated compound must be exactly as stated in the abbreviation.

As shown in FIG. 5, the contact surface 302 of the island formation 202 can be prepared with a roughened surface treatment prior to application of the first layer 502 of the wear and corrosion resistant coating 402. This pre-roughening treatment is optional, and can be imparted by blasting the annular surface 106 and 110 of the brake disk or rotor 100 with irregular shaped particles, as described above, such that the braking surface 302 includes a series of peaks and valleys with angular and irregular apexes at each peak and valley. Alternative surface textures may be rounded, cross-hatched, or woven in appearance, as described above. When a braking surface 302 prepared in this manner is subsequently coated with one or more coating layers of the wear and corrosion resistant coating 402, the resultant, substantially flat surface can exhibit a three dimensional appearance or woven texture. In addition, the composition and thickness of the layers forming the wear and corrosion resistant coating 402 can be selected to achieve desired light reflection and absorption characteristics in order to produce an attractive ornamental appearance that can include one or more ornamental colors.

As noted above, the island formations 202 or raised land portions on the annular surfaces 106 and 110 of a brake disk or rotor 100 can facilitate cooling of the brake disk or rotor 100 by increasing and directing air flow around and between the island formations during braking. By increasing the ability of the brake disk to dissipate heat, the risk of brake fade, wear and warpage is reduced, and can increase the effective service life of the brake disk or rotor. In addition, the channels or gaps 204 between adjacent island formations 202 reduce the overall weight of the brake disk or rotor 100, reducing the amount of material required. Finally, the island formations 202 can be designed to produce a visually attractive appearance in the visible portion of the brake disk, adding to the overall look of a vehicle such as a motor cycle where the brake disks are clearly visible.

Furthermore, brake disks or rotors 100 as well as brake drums prepared as described herein also offer distinct advantages in wear rates of brake pads or shoes used together with the brake disks or rotors 100 or brake drums. Braking performance equal to or greater than that of brake disks or rotors without the wear and corrosion resistant coating 402 is achieved using standard brake pads and brake disks or rotors that include the wear and corrosion resistant coating 402. In addition, the brake disk or rotor 100 with the wear and corrosion resistant coating 402 experiences a much slower wear rate than a brake disk or rotor 100 without the wear and corrosion resistant coating 402. Furthermore, the wear rate of the brake pads or shoes used in a braking system with a brake disk or rotor 100 with a wear and corrosion resistant coating 402 such as described herein is also substantially reduced, in some examples providing a functional lifetime of the brake pads or shoes that is 50% to 500% longer than that of the brake pads or shoes used in a braking system with a standard brake disk or rotor that does not have a wear and corrosion resistant coating 402 according to the current subject matter. In other examples, the wear rate of the brake pads or shoes used in a brake system with a brake disk or rotor 100 or a brake drum whose friction surfaces have a wear and corrosion resistant coating 402 and/or a plurality of island formations 202 as described herein can be reduced to no more than approximately 90% of the wear rate of the same brake pads or shoes used with a standard brake disk or rotor or a standard brake drum. In further implementations, the wear rate of the brake pads or shoes used in conjunction with a brake disk or rotor 100 or a brake drum whose friction surfaces have a wear and corrosion resistant coating 402 and/or a plurality of island formations 202 as described herein can be reduced to a range of approximately 20% to 40% of the wear rate of the same brake pads or shoes used with a standard brake disk or rotor or a standard brake drum.

Brake rotors according to the current invention were tested using a standard dynamometer test schedule which is summarized in Table 1. The test includes 14 sections or phases, which are listed in the first column of Table 1. The characteristics of each section or phase of the test are summarized based on number of stops in the section or phase, initial speed of the vehicle prior to each stop, final speed of the vehicle after each stop, pressure applied between the brake pads and the rotor, and the rate of deceleration.

TABLE 1
Dynamometer Test Schedule

| Section or | # of | Initial Speed | Final Speed | Pressure | Deceleration |
|---|---|---|---|---|---|
| Phase | Stops | (MPH) | (MPH) | (psi) | (ft · s⁻²) |
| Green | 9 | 20 | 0 | 100-900 | |
| Effectiveness | 9 | 40 | 0 | | |
| Burnish | 200 | 40 | 0 | | 9.0 |
| First | 9 | 20 | 0 | 100-900 | |
| Effectiveness | 9 | 40 | 0 | 100-900 | |
| | 9 | 60 | 0 | 100-900 | |
| | 9 | 90 | 0 | 100-900 | |
| First Fade | 10 | 60 | 0 | | 9.0 |
| First | 12 | 30 | 0 | | 9.0 |
| Recovery | | | | | |
| Reburnish | 35 | 40 | 0 | | 9.0 |
| Second | 9 | 20 | 0 | 100-900 | |
| Effectiveness | 9 | 40 | 0 | 100-900 | |
| | 9 | 60 | 0 | 100-900 | |
| | 9 | 90 | 0 | 100-900 | |
| Second Fade | 10 | 60 | 0 | | 9.0 |
| Second | 12 | 30 | 0 | | 9.0 |
| Recovery | | | | | |
| Third | 9 | 20 | 0 | 100-900 | |
| Effectiveness | 9 | 40 | 0 | 100-900 | |
| | 9 | 60 | 0 | 100-900 | |
| | 9 | 90 | 0 | 100-900 | |
| Wet | 9 | 20 | 0 | 100-900 | |
| Effectiveness | 9 | 40 | 0 | 100-900 | |
| | 9 | 60 | 0 | 100-900 | |
| | 9 | 90 | 0 | 100-900 | |
| Low Energy | 500 | 40 | 0 | | 7.0 |
| Durability | | | | | |
| High Energy | 500 | 60 | 0 | | 9.0 |
| Durability | | | | | |
| Final | 9 | 20 | 0 | 100-900 | |
| Effectiveness | 9 | 40 | 0 | 100-900 | |
| | 9 | 60 | 0 | 100-900 | |
| | 9 | 90 | 0 | 100-900 | |

Table 2 summarizes the results of tests according to the protocol summarized in Table 1 with Hawk Organic rotors. Identical Hawk Organic Pads (Model No. RGHP44002G) available from Wellman Products Group of Akron, Ohio) were tested under similar conditions using the protocol of Table 1. The first pad was tested with a polished but uncoated rotor that does not have a wear and corrosion resistant coating 402 or island formations 202 according to the current subject matter. The second pad was tested with a brake disk 100 having a wear and corrosion resistant coating 402 with a polished finish on the friction surfaces of the rotor 100. The brake pad used in these tests was analyzed using an Oxford Handheld Metal Analyzer that determines composition using X-ray fluorescence (model no. X-MET5100, available from Oxford Instruments U.S.A. of Scotts Valley, Calif.). The determined composition by mass was approximately 21.4% zirconium, 16.4% zinc, 13.7% iron, 0.55 strontium, 20.9% titanium, 13.9% copper, and 13.1% antimony.

As shown in Table 2, the pad tested with the rotor that included a wear and corrosion resistant coating 402 on the friction surfaces of the rotor 100 according to implementations of the current subject matter experienced approximately 90% less loss of mass in the performance test, better than 30% less wear by mass in the low energy durability test, and approximately 85% less wear by mass in the high energy durability test. The rotor with the wear and corrosion resistant coating 402 experienced a nearly statistically insignificant loss of mass—at least 98% slower mass wear rate than the uncoated rotor. The thickness of the rotor with the wear and corrosion resistant coating 402 also decreased in thickness by amount that was smaller than the resolution of the instruments and that was at least 95% less than that of the uncoated rotor.

TABLE 2
Results of testing of uncoated and coated rotors.

| | | Performance | Low Energy | High Energy | |
|---|---|---|---|---|---|
| | | Test (Pad | Durability | Durability | |
| Test System | | Wear) | (Pad Wear) | (Pad Wear) | Rotor Wear |
| Hawk Pad | Wear (inches) | 0.0515 | 0.0057 | 0.299 | 0.0011 |
| with | Weight Loss | 3.1 | 1.1 | 5.2 | 6.3 |
| Uncoated | (grams) | | | | |
| Rotor | | | | | |
| Hawk Pad | Wear (inches) | 0.0025 | 0.0043 | 0.0026 | 0.00004 |
| with Rotor | Weight Loss | 0.3 | 0.8 | 0.8 | 0.1 |
| according to | (grams) | | | | |
| current | | | | | |
| subject | | | | | |
| matter | | | | | |

The subject matter disclosed herein also includes both solid and floating rotor designs for a brake rotor or disk assembly. In general, a solid rotor design is one in which the rotor is cast, molded or machined in a single piece that bolts directly to the wheel or drive plate of the vehicle. A floating rotor is typically cast, molded or machined in two pieces. An outer, annular part (typically referred to as the “friction ring”) has a first central opening within which an inner part (typically referred to as the “carrier or hub”) is positioned. The inner part has a second central opening for mounting of the brake and disk rotor assembly on a wheel hub. The inner part and outer parts are attached in a non-rigid fashion by a series of buttons that are positioned about the outer circumference of the inner part and the outer part. The buttons protrude above and below the circular faces. Typically these buttons are spring-loaded in order to allow the friction ring to center itself with the brake caliber. The inner part includes lug nut holes to match with wheel lug nuts or mounting hardware on a wheel hub to which the brake rotor or disk assembly is installed.

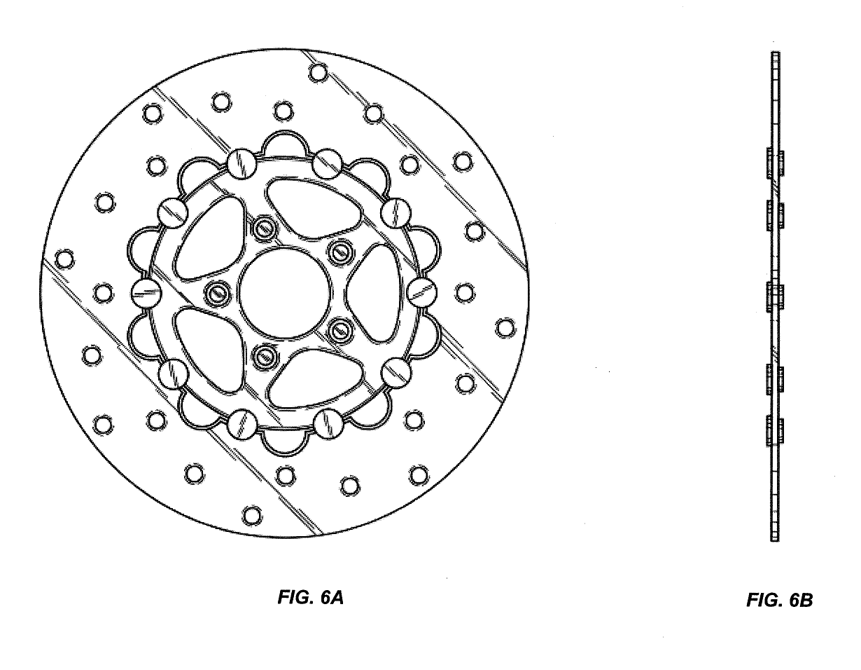

FIG. 6 to FIG. 13 each show front and side views of floating rotor assemblies. Each of these assemblies is based on a combination of an inner part or carrier and an outer part or rotor as described above. FIGS. 6A, 7A, 8A, 9A, 10A, 11A, 12A, and 13A each show one of the circular faces of the brake rotor or disk assembly. The opposite circular face for each brake rotor or disk assembly is a mirror image of the view shown. FIGS. 6B, 7B, 8B, 9B, 10B, 11B, 12B, and 13B each show an edge view of the brake rotor or disk assembly. Other edges can be similar. However, the relative positions of the protruding buttons in each edge view can vary slightly depending on the angle of the view.

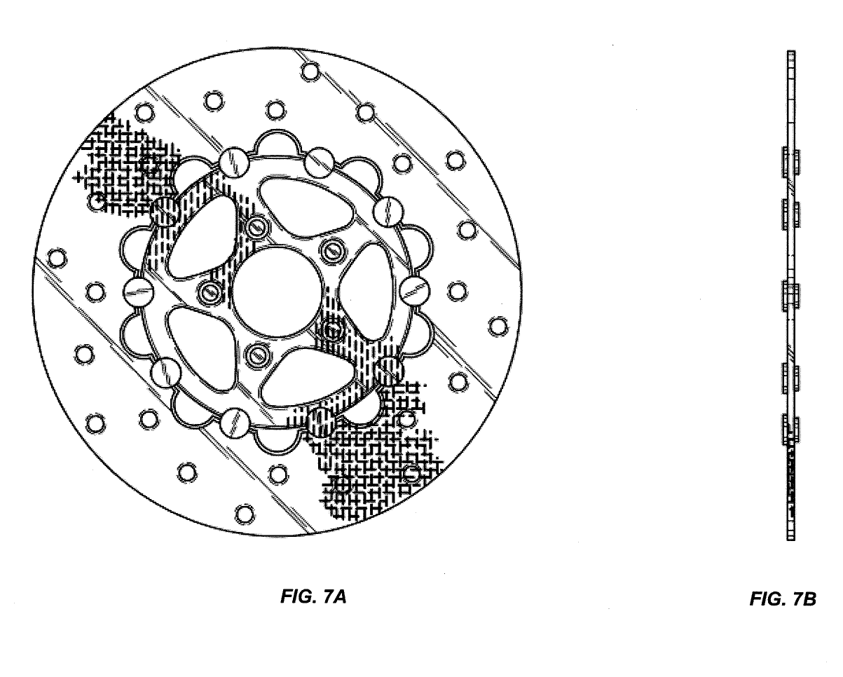

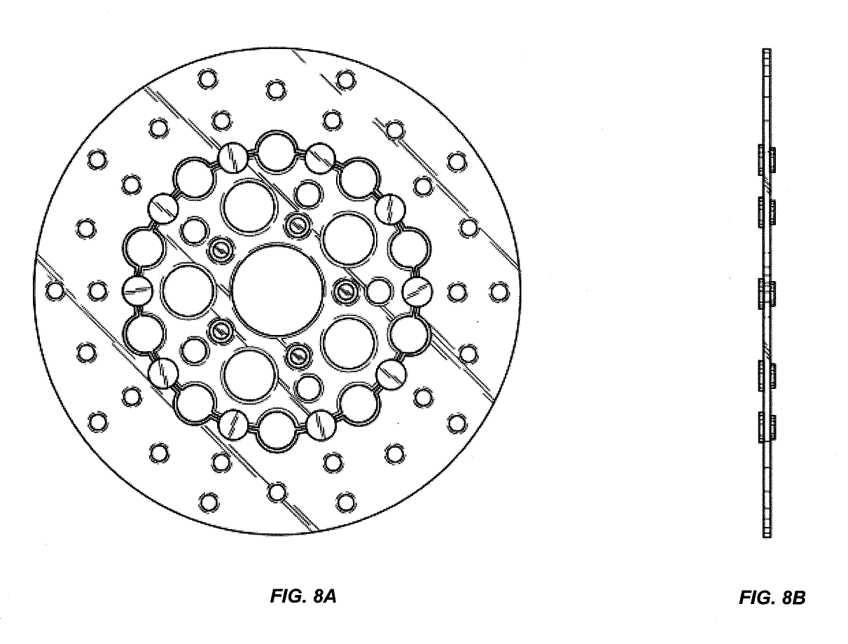

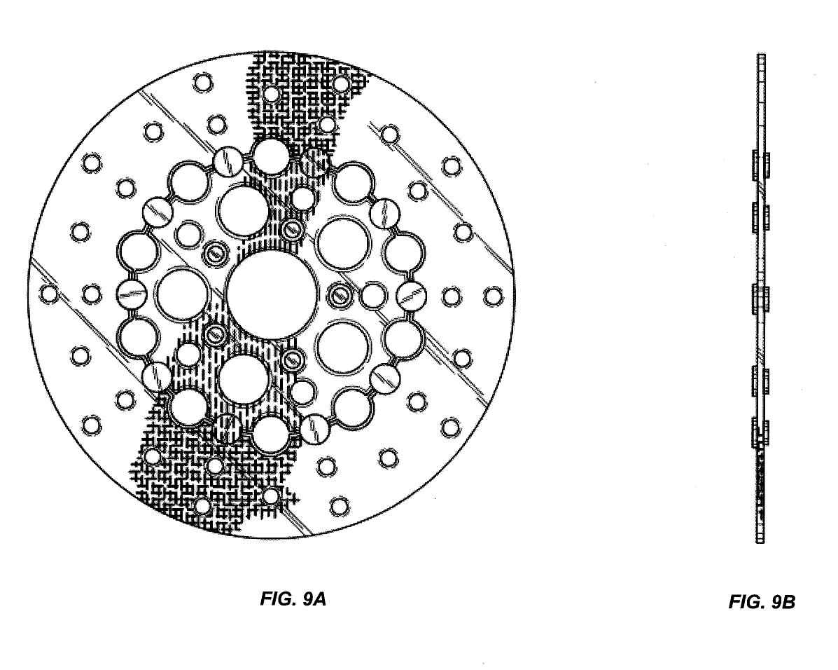

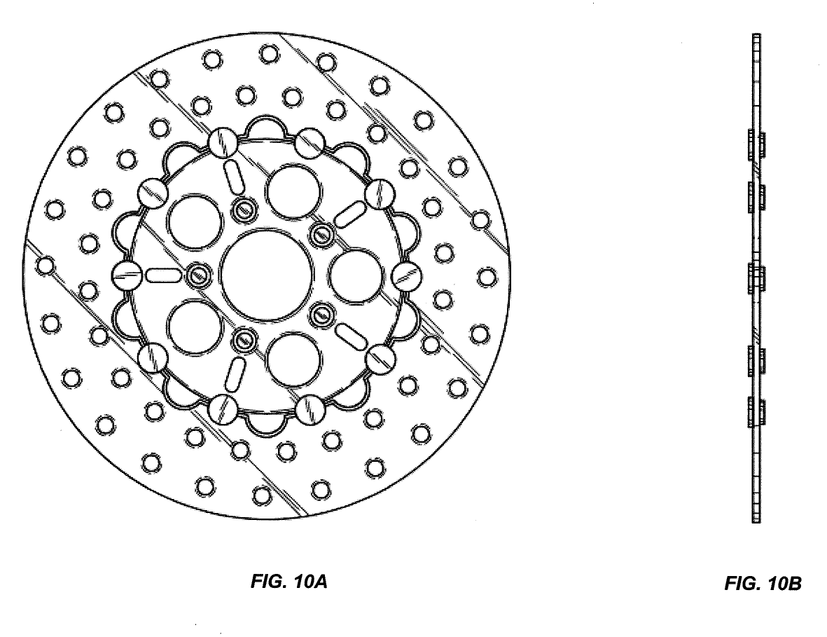

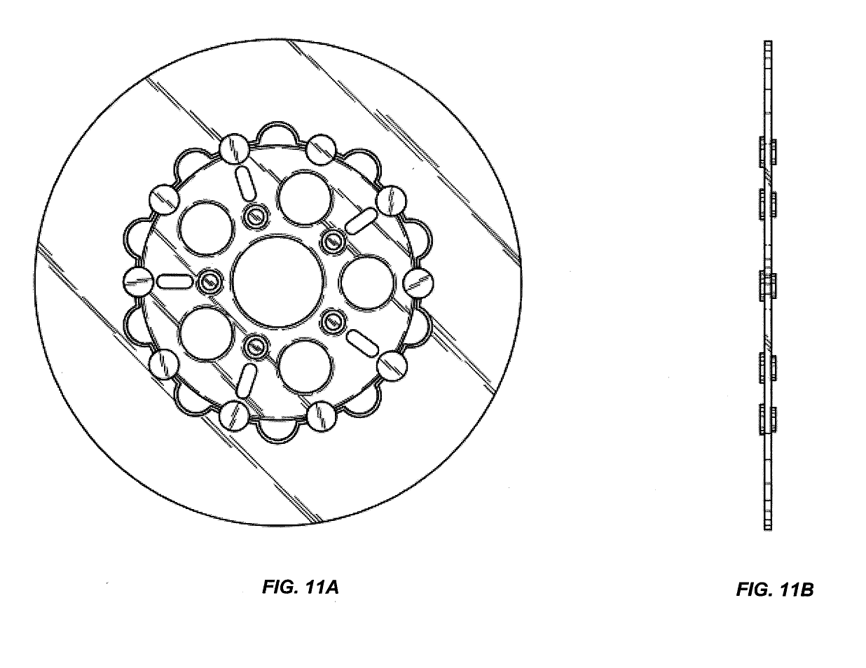

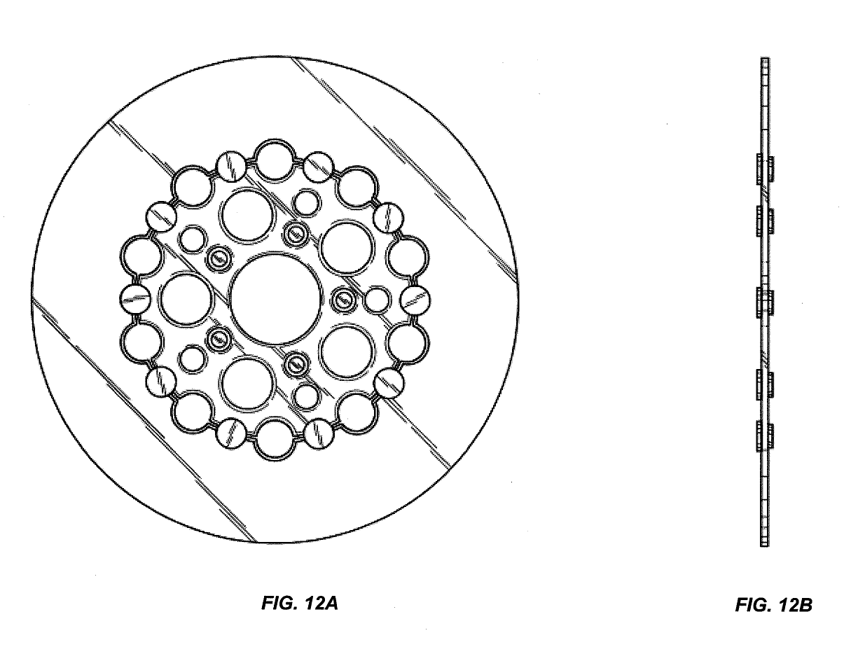

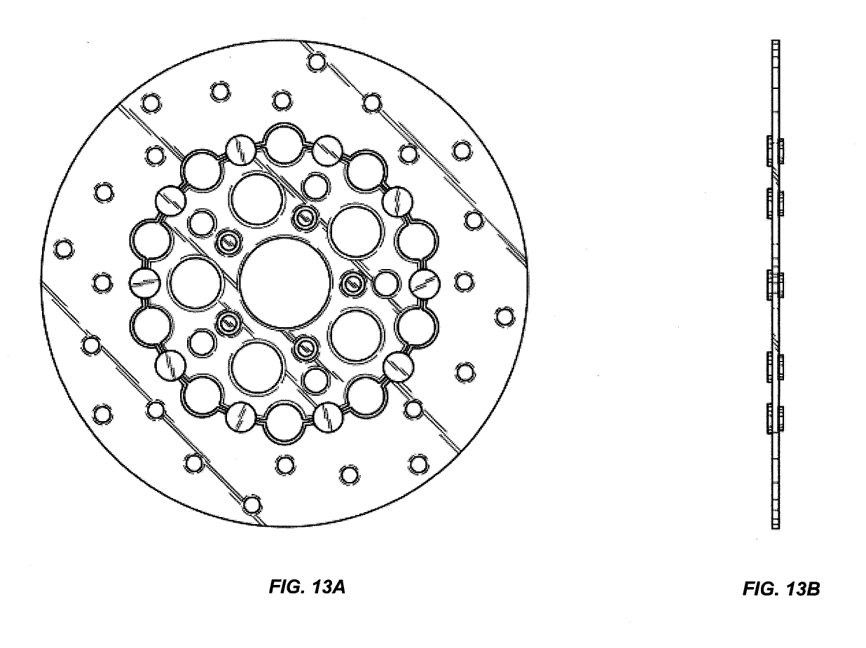

Three inner part or carrier configurations are shown in FIGS. 6-13. FIG. 6 and FIG. 7 show a “star” configuration for the inner part; FIG. 8, FIG. 9, FIG. 12, and FIG. 13 each show an “orbit” configuration for the inner part; and FIG. 10 and FIG. 11 show a “pulsar” configuration for the inner part.

The “star” configuration for the inner part is circular in shape with approximately semicircular notches disposed about the circumference to accept the buttons. A non-circular opening is included between each pair of lug nut holes to provide an open appearance.

The “orbit” configuration for the inner part is circular in shape with a first set of approximately semicircular notches disposed about the circumference to accept the buttons. A second set of larger and approximately semicircular notches are also disposed about the circumference and positioned between each pair of notches for accepting the buttons. A first set of circular holes are disposed such that each is centered along one of a first set of radii that are directed at each of the notches for accepting the buttons. A second set of smaller holes are disposed such that each is centered along one of a second set of radii that are directed at each of the set of larger, approximately semicircular notches. The lug nut holes in the orbit configuration are disposed such that each is centered along one of the second set of radii.

The “pulsar” configuration for the inner part is circular in shape with approximately semicircular notches disposed about the circumference to accept the buttons. A rounded slot and a circular hole pattern are arranged directed inwardly toward the center of the inner part from each of the notches for accepting the buttons.

FIG. 6, FIG. 7, and FIG. 13 show a first configuration for the outer part having a circular central opening that includes a pattern of alternating larger and smaller approximately semicircular cutouts. The smaller cutouts accept the buttons when the first configuration of the outer part is assembled to or with one of the inner parts. The larger cutouts are arranged to match up to form approximately circular holes when this first outer part is combined with the “orbit” rotor to form the rotor or disk assembly shown in FIG. 13. With the “star” and “pulsar” configurations of the inner part, the larger semicircular notches of the second configuration of the outer part merely form approximately semicircular holes when the rotor or disk assembly is completed as shown in FIG. 6 and FIG. 8, respectively. The first configuration for the outer part also includes pass-through holes disposed in a repeating pattern around the outer part between the annular central hole and the outer peripheral edge.

FIG. 8, FIG. 9, and FIG. 10 show a second configuration for the outer part having a circular central opening that includes a pattern of alternating larger and smaller approximately semicircular cutouts. The smaller cutouts accept the buttons when the second configuration of the outer part is assembled to or with one of the inner parts. The larger cutouts are arranged to match up to form approximately circular holes when this first outer part is combined with the “orbit” rotor to form the rotor or disk assembly shown in FIG. 11. With the “star” and “pulsar” configurations of the inner part, the larger semicircular notches of the second configuration of the outer part merely form approximately semicircular holes when the rotor or disk assembly is completed as shown for example in FIG. 10 for the “pulsar” configuration of the inner part. The second configuration for the outer part also includes pass-through holes disposed in a repeating pattern around the outer part between the annular central hole and the outer peripheral edge. The pass-through holes of the outer parts shown in FIG. 8, FIG. 9, and FIG. 10 have more holes than the first configuration for the outer part as shown in FIG. 6, FIG. 7, and FIG. 13.

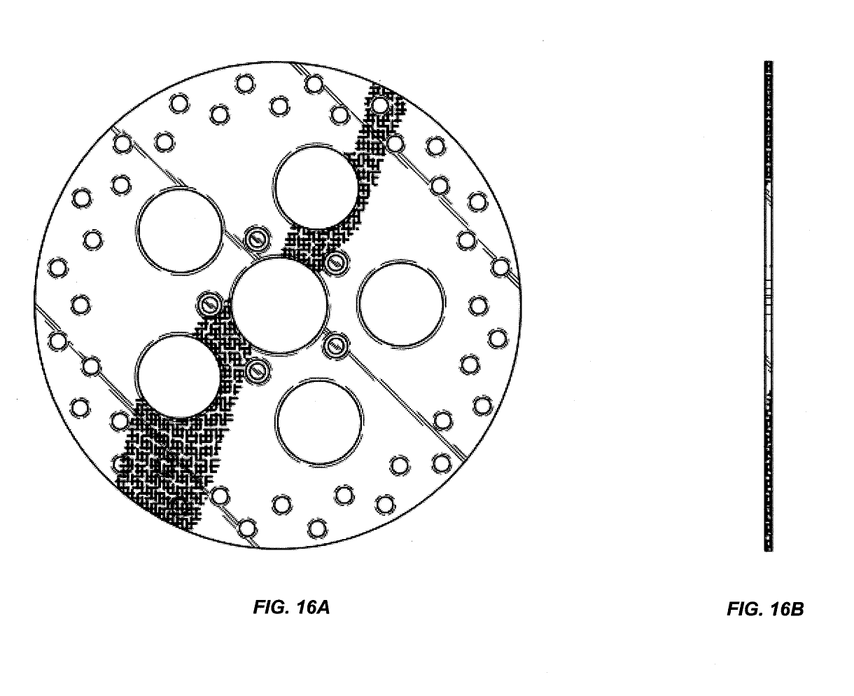

FIG. 11 and FIG. 12 show a third configuration for the outer part having a circular central opening that includes a pattern of alternating larger and smaller approximately semicircular cutouts. The smaller cutouts accept the buttons when the third configuration of the outer part is assembled to or with one of the inner parts. The larger cutouts are arranged to match up to form approximately circular holes when this first outer part is combined with the “orbit” rotor to form the rotor or disk assembly shown in FIG. 12. With the “star” and “pulsar” configurations of the inner part, the larger semicircular notches of the third configuration of the outer part merely form approximately semicircular holes when the rotor or disk assembly is completed as shown for example in FIG. 16 for the “pulsar” configuration of the inner part. The third configuration for the outer part does not include pass-through holes disposed in a repeating pattern around the outer part as in the first and the second configurations of the outer part.

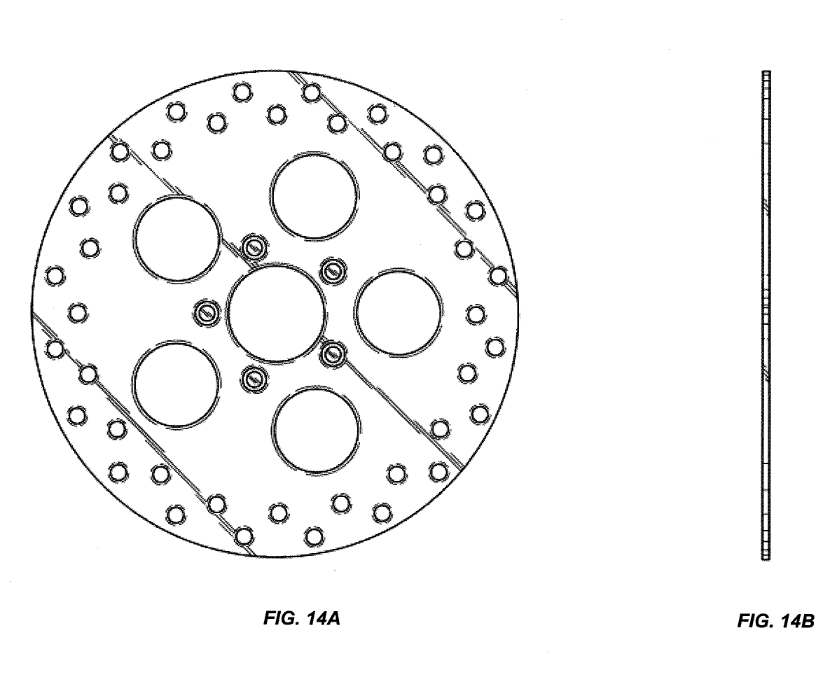

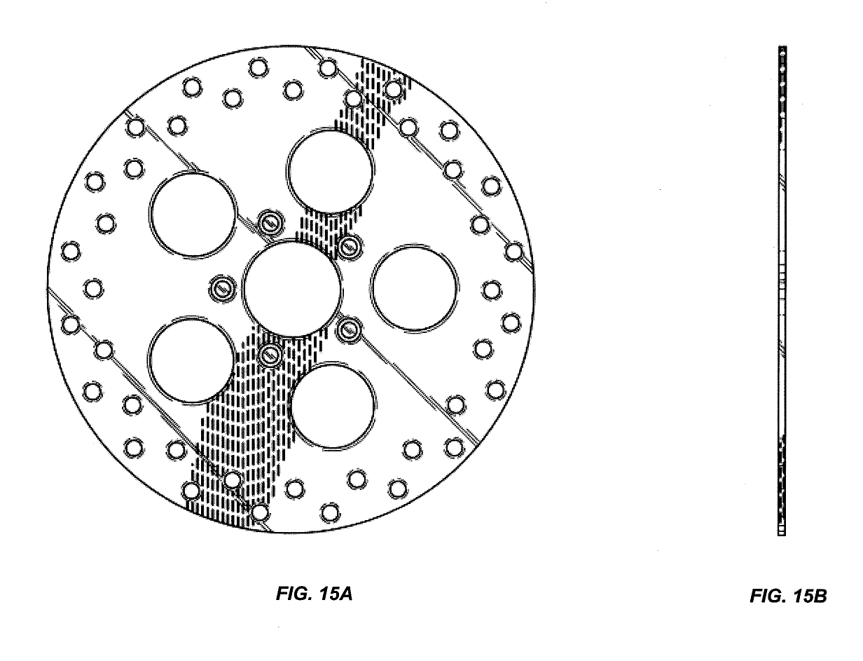

FIGS. 14-16 show examples of a rigid rotor having different color coatings or textures as discussed below. Lug nut holes are arranged in an evenly spaced radial pattern about the central hole. A larger circular hole is disposed along a radius the passes between each pair of the lug nut holes. A pattern of smaller pass-through holes is disposed in a repeating pattern closer to the outer edge of the rotor.

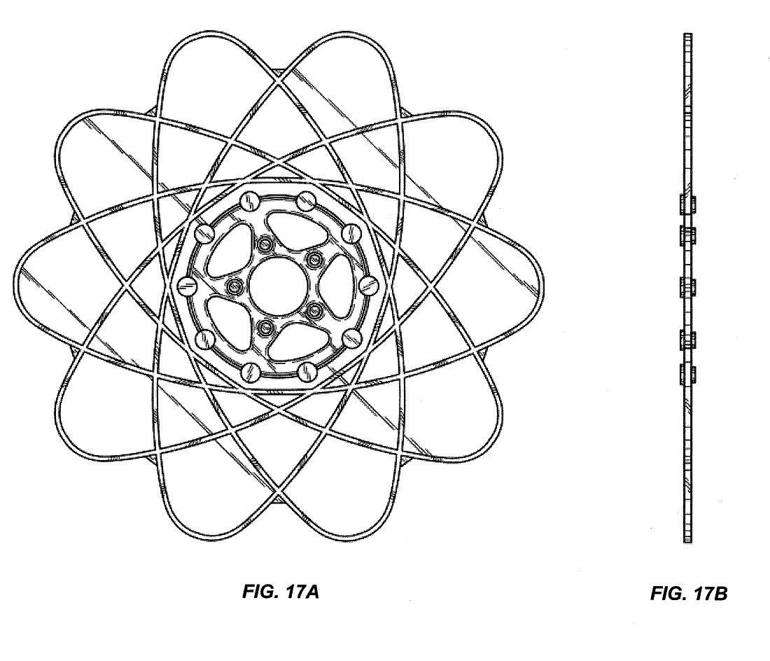

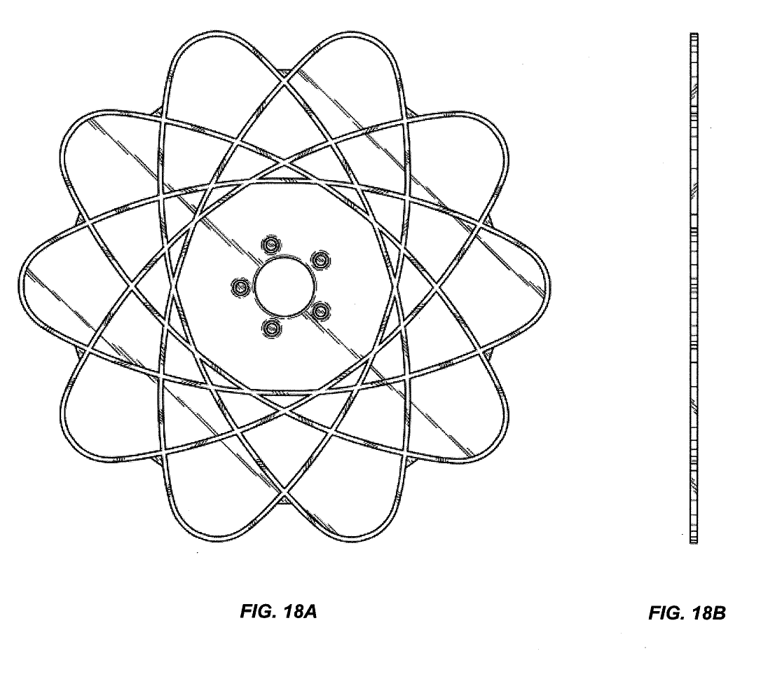

FIG. 17 and FIG. 18 show side and edge plan views of an additional rotor design that includes an atomic orbital pattern. FIG. 17A and FIG. 17B are the facing and edge plan views of a floating brake rotor or disk assembly in which the outer part includes the atomic orbital pattern as shown. The atomic orbital pattern is formed on the surface of the outer part as grooves cut into the faces. The opposite face of the assembly is a mirror image of that shown in FIG. 17A. The outer part shown in FIG. 17A is used in conjunction with the “star” inner part discussed above. Any of the other configurations for the inner part can also be used.

FIG. 18A and FIG. 18B are the facing and edge plan views of a rigid brake rotor that includes the atomic orbital pattern as shown. The atomic orbital pattern is formed on the surface of the outer part as grooves cut into the faces. The opposite face of the assembly is a mirror image of that shown in FIG. 18A. Lug nut holes are disposed in a radial pattern about the central hole for the wheel hub.

The components of the brake rotor or disk assembly include a coating that can have a metallic appearance. For rigid rotors as shown in FIGS. 14-16 and FIG. 18, the coating can be uniformly applied to the entire rigid rotor. The lug nuts used with the rigid rotor can have either a matching or a complementary color to that of the rotor. For floating rotors such as those shown in FIG. 6 to FIG. 13, the inner part, the outer part, the buttons, and the lug nuts can be colored in any foreseeable combination of the coating colors. The coating colors include a polished gold, a polished chrome, a polished light gold, a satin gold, and a satin chrome. The surfaces of the outer and optionally of the inner parts can also be treated prior to application of the coating so as to have a textured appearance or even to include one or more word, letter, number, or logo characters or a combination thereof such as for example those shown in FIG. 7. The buttons and the lug nuts as well as other braking system components can also be treated prior to application of the coating so as to have a textured appearance or even to include one or more word, letter, number, or logo characters or a combination thereof.

In further implementations, a brake rotor assembly can include one or more colored finishes presented on the inner part, the outer part, and the buttons. These colored finishes can optionally be created using a wear-resistant coating such as those described above and in the priority applications whose benefit is claimed above and which have been previously incorporated by reference. Any one-piece rotor, including but not limited to those shown in the attached figures, can be presented in colors including gold, light gold, chrome, black, red, mauve, gray, dark gray, pink, green, blue, and others. Each color can be presented in a polished or a satin finish.

The use of different colored finishes on the different parts of a brake rotor assembly can provide the ability to vary the décor of a previously solely utilitarian component of a vehicle. Because a floating rotor can be disassembled and reassembled using the proper tools, a user can easily change the friction ring (outer part), the carrier (inner part), and/or the buttons of the brake rotor assembly relative to the other parts to create a new appearance without the need to purchase an entirely new rotor assembly. In some implementations, a brake rotor system can include one or more inner parts, optionally of different colors, provided in conjunction with one or more outer parts, also optionally of different colors, and one or more sets of buttons, also optionally of different colors. For example, if the brake rotor system included two differently colored outer parts, a single inner part, and two different colored sets of buttons, the end-user could create four unique appearances. Inclusion of a second differently colored inner part doubles the available color scheme choices to eight. Brake rotor components including wear-resistant coatings, such as those described herein and in the incorporated priority documents, have a much longer useful lifetime than conventional brake rotor components. From a manufacturer's or a retailer's standpoint, this can lead to reduced future sales of such braking components from existing customers. If the parts do not wear out or if they wear out substantially more slowly than previously available parts, the customer has no reason to purchase replacements. However, providing a user with the ability to vary the color scheme of his or her rotor assembly or of other parts of the braking system without having to purchase an entire new rotor assembly can drive added purchases of one or more baking system components and thereby increase product sales.

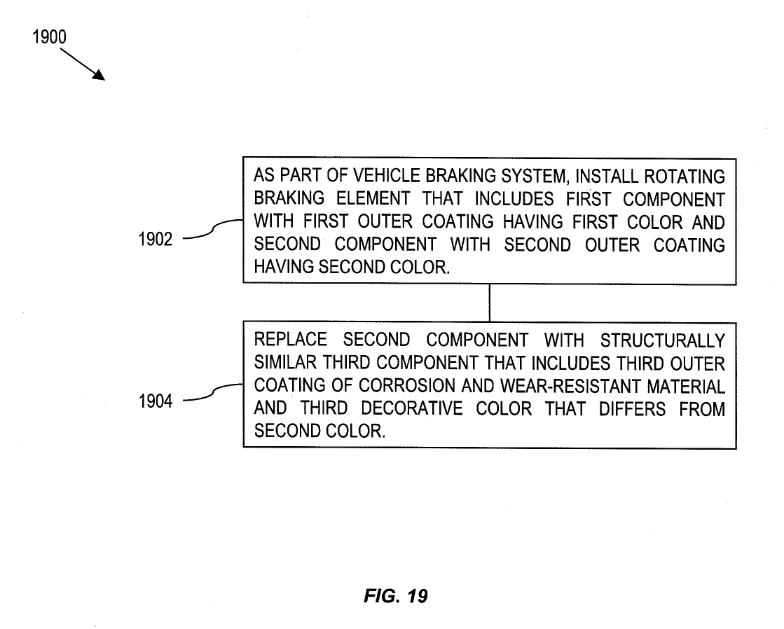

FIG. 19 shows a process flow chart 19 illustrating a method consistent with this implementation. At 1902, a rotating braking element is installed as part of a vehicle braking system. The rotating braking element includes a first component and a second component. The first component includes a first outer coating that includes a corrosion and wear-resistant material. The first outer coating includes a first decorative color whose color and original appearance are substantially retained after repeated uses of the vehicle braking system in stopping or slowing the vehicle. The second component includes a second outer coating that includes the corrosion and wear-resistant material. The second outer coating includes a second decorative color whose color and original appearance are substantially retained after repeated uses of the vehicle braking system in stopping or slowing the vehicle. At 1904, the second component s replaced with a structurally similar third component. The third component includes a third outer coating that includes the corrosion and wear-resistant material, the third outer coating includes a third decorative color whose color and original appearance are substantially retained after repeated uses of the vehicle braking system in stopping or slowing the vehicle.

While the first and the second colors can be the same, the third color differs from the second color. The first component and the second and third components can be any part of a braking system on a vehicle, including but not limited to solid rotors, inner or outer parts of a floating rotor assembly, lug nuts, buttons, calipers, structural supports, or the like. The colors for each of the first, second, and third components can be selected from those listed elsewhere in this document as well as from other colors.

The implementations set forth in the foregoing description do not represent all implementations consistent with the subject matter described herein. Instead, they are merely some examples consistent with aspects related to the described subject matter. Wherever possible, the same reference numbers will be used throughout the drawings to refer to the same or like parts. Although a few variations have been described in detail above, other modifications or additions are possible. In particular, further features and/or variations may be provided in addition to those set forth herein. For example, the implementations described above may be directed to various combinations and subcombinations of the disclosed features and/or combinations and subcombinations of several further features disclosed above. In addition, the logic flow depicted in the accompanying figures and/or described herein do not require the particular order shown, or sequential order, to achieve desirable results. Other embodiments may be within the scope of the following claims.

What is claimed:

1. A braking system for stopping or slowing a vehicle, comprising:
a rotating braking element that comprises a bulk structural material and a friction surface, the friction surface comprising an outer coating that comprises a corrosion and wear-resistant material, the rotating brake element being adapted for installation as part of a braking system on the vehicle, the vehicle braking system also including a movable brake member that comprises a friction material having a friction material composition, the movable brake member being disposed in the braking system with the friction material disposed opposite the at least one friction surface so that the friction material reversibly engages with the outer coating of the corrosion and wear-resistant material when the braking system is operated to stop or slow the vehicle; and
wherein the outer coating of the corrosion and wear-resistant material comprises a decorative color whose color and original appearance are substantially retained after repeated uses in stopping or slowing the vehicle.

2. A braking system as in claim 1, wherein the outer coating of the corrosion and wear-resistant material comprises a first layer comprising a crystalline material and a second layer overlaying and contacting the first layer and comprising an amorphous material.

3. A braking system as in claim 2, wherein the friction surface comprises a plurality of raised island formations separated by channels or gaps that permit air flow to cool the rotating braking element during active engagement with the brake member.

4. A braking system as in claim 2, wherein the first layer and the second layer have an inter-layer period of less than 10 nm and the outer coating comprises a superlattice structure.

5. A braking system as in claim 2, wherein the first layer comprises one or more amorphous metals and the second layer comprises one or more binary metals.

6. A braking system as in claim 5, wherein the amorphous metal of the first layer is selected from titanium, chromium, zirconium, aluminum, hafnium and an alloy combination thereof; and wherein the binary metal of the second layer is selected from a metal nitride, a metal boride, a metal carbide and a metal oxide.

7. A braking system as in claim 5, wherein the second layer further comprises one or more nitrides, borides, carbides or oxides of the amorphous metal of the first layer.

8. A braking system as in claim 1, wherein the rotating braking element comprises an inner part, an outer part, and one or more buttons that join the inner part and outer part to from a floating rotor assembly.

9. A braking system as in claim 1, wherein the rotating braking element comprises an inner part, an outer part, and one or more buttons that join the inner part and outer part to from a floating rotor assembly.

10. A braking system as in claim 1, wherein the decorative color comprises one or more of gold, light gold, chrome, black, red, mauve, gray, dark gray, pink, green, and blue.

11. A method for varying an appearance of a vehicle braking system comprising:
installing a rotating braking element as part of the vehicle braking system, the rotating braking element comprising a first component and a second component, the first component comprising a first outer coating that comprises a corrosion and wear-resistant material, the first outer coating comprising a first decorative color whose color and original appearance are substantially retained after repeated uses of the vehicle braking system in stopping or slowing the vehicle, the second component comprising a second outer coating that comprises the corrosion and wear-resistant material, the second outer coating comprising a second decorative color whose color and original appearance are substantially retained after repeated uses of the vehicle braking system in stopping or slowing the vehicle; and
replacing the second component with a structurally similar third component, the third component comprising a third outer coating that comprises the corrosion and wear-resistant material, the third outer coating comprising a third decorative color whose color and original appearance are substantially retained after repeated uses of the vehicle braking system in stopping or slowing the vehicle the third color differing from the second color.

12. A method as in claim 11, wherein the corrosion and wear-resistant material comprises a first layer comprising a crystalline material and a second layer overlaying and contacting the first layer and comprising an amorphous material.

13. A method as in claim 12, wherein the first layer and the second layer have an inter-layer period of less than 10 nm and the outer coating comprises a superlattice structure.

14. A method as in claim 12, wherein the first layer comprises one or more amorphous metals and the second layer comprises one or more binary metals.

15. A method as in claim 14, wherein the amorphous metal of the first layer is selected from titanium, chromium, zirconium, aluminum, hafnium and an alloy combination thereof, the binary metal of the second layer is selected from a metal nitride, a metal boride, a metal carbide and a metal oxide.

16. A method as in claim 14, wherein the second layer further comprises one or more nitrides, borides, carbides or oxides of the amorphous metal of the first layer.

17. A method as in claim 11, wherein the first component comprises one of a solid brake rotor, an inner part of a floating rotor assembly, and outer part of a floating rotor assembly, a lug nut, and a button that joins the inner part and outer part to from the floating rotor assembly.

18. A method as in claim 11, wherein the first color and the second color comprise two different metallic colors.
